(19) United States
(12) Patent Application Publication
(10) Pub. No.: US 2025/0092618 A1
(43) Pub. Date: Mar. 20, 2025

(54) EDGE DETECTION SYSTEM AND METHOD OF DETECTING AN EDGE

(71) Applicant: JOSEPH VÖGELE AG, Ludwigshafen/Rhein (DE)

(72) Inventors: Ralf WEISER, Ladenburg (DE); Philipp STUMPF, Heidelberg (DE)

(73) Assignee: JOSEPH VÖGELE AG, Ludwigshafen/Rhein (DE)

(21) Appl. No.: 18/889,639

(22) Filed: Sep. 19, 2024

(30) Foreign Application Priority Data
Sep. 19, 2023 (EP) 23198331.3

(51) Int. Cl. E01C 23/01; E01C 19/48; G01S 17/42; G01S 17/88

(52) U.S. Cl. CPC E01C 23/01; E01C 19/4873; G01S 17/42; G01S 17/88; E01C 2301/14

(57) ABSTRACT

An edge detection system for a road paver, wherein the edge detection system includes a sensor unit, which is configured to emit laser pulse sequences into a plurality of directions in such a way that the laser pulse sequences are reflected at a plurality of locations of a surface to be scanned. The sensor unit is further configured to detect reflections of the laser pulse sequences and, based on the detected reflections, generate polar coordinate signals representing polar coordinates, wherein the polar coordinates include a distance and an associated angle. The edge detection system is configured to transform the polar coordinate signals into Cartesian coordinate signals representing Cartesian coordinates and to determine a position of an edge in the surface to be scanned relative to a Cartesian coordinate system based on the Cartesian coordinate signals.

### CROSS-REFERENCE TO RELATED APPLICATIONS

This application claims foreign priority benefits under 35 U.S.C. § 119 (a)-(d) to European patent application number EP 23198331.3, filed Sep. 19, 2023, which is hereby incorporated herein by reference in its entirety.

### TECHNICAL FIELD

The disclosure relates to detecting edges as references for laying of road pavements.

### BACKGROUND

Road pavements such as asphalt layers are frequently laid using road pavers. In order to provide for a desired course of the road pavement, in particular of its lateral edges, references are used, along which the road paver, in particular its screed can be guided. Among those references are wires or edges. Examples for edges used as a reference are curb edges, edges of previously laid pavement layers or milling edges resulting from removal of pavement layers to be replaced. Guiding the road paver or a screed, respectively, or its extension parts along the reference is still often achieved by manual control of operating personnel. Further automatization is desired. One challenging objective is to detect the course of the reference. WO 2020088782 A1 discloses a sensor system comprising a laser scanner for a construction machine, in particular a road paver. This is supposed to enable following by steering the road paver or extending or contracting of extendable screed parts.

### SUMMARY

It is an object of the disclosure to provide an improved system or method for edge detection. This object is achieved by an edge detection system having advantageous features and developments as described herein.

An edge detection system for a road paver is disclosed. The edge detection system comprises a sensor unit, which is configured to emit laser pulse sequences into a plurality of directions in such a way that the laser pulse sequences are reflected at a plurality of locations of a surface to be scanned. The sensor unit is further configured to detect reflections of the laser pulse sequences and, based on said detected reflections, generate polar coordinate signals representing polar coordinates, wherein the polar coordinates comprise a distance value and an associated angle value. The edge detection system is further configured to transform the polar coordinate signals into Cartesian coordinate signals representing Cartesian coordinates and to determine a position of an edge in the surface to be scanned relative to a Cartesian coordinate system based on the Cartesian coordinate signals. The transformation into Cartesian coordinate signals may enable processing techniques, which, in contrast to approaches from the prior art, work without requiring radiation intensity.

The surface to be scanned may for example be an underground or a portion of the underground, on which the road paver is driving and or applying the road pavement. The edge detection system may, in addition to the sensor unit, comprise further components, for example a control unit. The components of the edge detection system may be interconnected, for example to transmit signals and or exchange data. For example, the connections between the components of the edge detection system may comprise one or more ethernet connections and or one or more CAN bus connections. The edge detection system may comprise a plurality of sensor units. Each sensor unit may have an address such as an IP address. The address may be statically programmed into each sensor unit or assigned to each sensor unit, for example by the control unit. For example, the control unit may be configured to assign an address to one, several or all of the sensor units based on a connector, by which the respective sensor unit is connected to the control unit.

The control unit may be configured to implement various functionalities of the edge detection system. For example, the control unit may be embodied as a separate electronic circuit or as a part of a central control unit of the screed or of the road paver. Laser pulse sequences may be understood as Laser signals comprising a finite number of periods, in particular one or more periods.

In the following, the expression “function” is used in a general, mathematical sense. For example, it may be understood as a relation between two sets, in which each element of the first set is assigned to exactly one element of the second set. The Association may for example be given by a mathematical formula or by a plurality of, for example discrete, ordered peers such as coordinate pairs. An ordered pair may each comprise an argument, for example a first coordinate or x-coordinate, and a value of the function, for example a second coordinate or a y-coordinate or a slope. The edge detection system may be configured to determine and interpolating function based on the Cartesian coordinate signals. The interpolating function may be regarded as a representation of the contour of the surface to be scanned. Characteristic locations of the contour may be mathematically determined by curve sketching.

The edge detection system may be configured to determine a smoothed function based on the interpolating function and or based on the Cartesian coordinate signals. Smoothing may avoid errors in the evaluation, which could for example be caused by measuring noise in the un-smoothed function. The smoothed function may comprise a plurality of ordered pairs. For example, the ordered pairs may each comprise a first coordinate or and x-coordinate as an argument and a second coordinate or a y-coordinate as a value of the function.

The edge detection system may be configured to differentiate the smoothed function and to determine a derivative function. The derivative function may comprise a plurality of ordered pairs. For example, the ordered pairs may each comprise a first coordinate or an x-coordinate as an argument and a slope, for example a slope of the smoothed function at the respective argument or at the respective x-coordinate, as a value of the function. Since the derivative function may represent the course of the slope of the smoothed function, it may be determined where changes of direction in the contour of the surface to be scanned are located by evaluating the derivative function.

The edge detection system may be configured to determine the smallest minimum and or the largest maximum of the derivative function. For example, the derivative function may be differentiated one more time and the zeros of the second derivative function so obtained may be determined. The edge detection system may further be configured to, while determining the smallest minimum and or the largest maximum of the derivative function, disregard locations, at which the value of the derivative function are smaller than a threshold value. In this way, it may be prevented that in absence of a distinctive extremum, randomly distributed values are outputted continually.

The edge detection system may be configured to, based on the argument of the derivative function at the smallest minimum and or at the largest maximum, determine an edge distance value, which may represent an edge distance between the edge in the surface to be scanned and the sensor unit.

The sensor unit may further comprise a 2-D lidar sensor. The sensor unit may be configured to emit laser pulse sequences in the infrared spectrum. For example, the sensor unit may be configured to emit infrared laser pulses. The sensor unit may further comprise a photodiode. The photodiode may be configured to detect reflections of the laser pulse sequences, for example reflections in the infrared spectrum and or reflections of infrared laser pulses. The sensor unit or the edge detection system may be configured to determine a distance value based on transit-time measurement.

All of the directions of the plurality of directions may be in the same plane. The sensor unit may for example comprise a rotating mirror. The mirror may be configured to deflect the laser pulse sequences in the infrared spectrum and or infrared laser pulses into the plurality of directions. The sensor unit or the edge detection system may further be configured to determine an angle value based on an orientation of the mirror. The rotation frequency of the mirror may be between 1 Hz and 100 Hz, in particular between 1 Hz and 50 Hz, particularly preferred between 1 Hz and 30 Hz. The rotation frequency of the mirror may for example be 15 Hz. The sensor unit and or the edge detection system may be configured to evaluate measurements in a range between −35° and 35°.

The edge detection system may further comprise a second sensor unit and may be configured to distinguish between the sensor unit and the second sensor unit based on their IP addresses. Alternatively or additionally, the edge detection system may be configured to distinguish between the sensor unit and the second set sensor unit based on their mounting position, for example the side and or the lateral shield of the screed, at which they are mounted. Alternatively or additionally, the edge detection system may be configured to distinguish between the sensor unit and the second sensor unit based on connectors, with which the respective sensor unit is connected to other components of the edge detection system, for example a control unit.

The disclosure also relates to a screed for a road paver comprising an edge detection system of the type described above. The screed may comprise at least one extension part, preferably two extension parts. The edge distance may be defined in parallel to an extension direction of the extension part. The movement of the extension part or the extension parts may be controllable based on an output of the edge detection system.

A sensor unit may be provided at one, several or all of the extension parts present on the screed. In particular, a side shield may be mounted at one, several or all of the extension parts present on the screed. The sensor unit or the sensor units may each be provided at one of the side shields. The sensor unit or the sensor units may each be disposed at the extension part or at the side shield in such a way that the plane is oriented at an angle relative to the surface to be scanned, the angle being greater than 0° and smaller than 180°, in particular being 90°.

The screed may have a path measuring device and or a width control. The path measuring device may be configured to determine extension paths of each of the extension parts. The width control may be configured to set a predetermined target with by moving one or several or all extension parts.

The disclosure also relates to a road paver comprising an edge detection system of the type described above or a screed of the type described above. The plane and a driving direction of the road paver may enclose an angle which is larger than 0° and/or smaller than 180°, preferably larger than 75° and/or smaller than 105°. In particular, the plane may be oriented orthogonally with respect to a driving direction of the road paver.

The disclosure also relates to a method of detecting an edge by an edge detection system for a road paver, wherein the edge detection system comprises a sensor unit. The method comprises emitting laser pulse sequences into a plurality of directions by the sensor unit such that the laser pulse sequences are reflected at a plurality of locations of a surface to be scanned, detecting reflections of the laser pulse sequences by the sensor unit and generating polar coordinate signals representing polar coordinates based on the detected reflections, wherein the polar coordinates comprise a distance value and an associated angle value. The method further comprises transforming the polar coordinate signals into Cartesian coordinate signals representing Cartesian coordinates and determining a position of an edge in the surface to be scanned relative to a Cartesian coordinate system based on the Cartesian coordinate signals.

The surface to be scanned may, for example, be an underground or a portion of the underground, on which the road paver is driving and or laying the road pavement.

The method may further comprise determining an interpolating function based on the Cartesian coordinate signals.

The method may further comprise determining a smoothed function based on the interpolating function and or based on the Cartesian coordinate signals. Smoothing the function may, for example, prevent errors during the evaluation, which may for example result from measurement noise in the un-smoothed function.

The method may further comprise differentiating the smoothed function and determining a derivative function. Since the derivative function represents the course of the slope of the smoothed function, it may be determined where changes of direction in the contour of the surface to be scanned are located by evaluating the derivative function.

The method may further comprise determining the smallest minimum and or the largest maximum of the derivative function. For example, the derivative function may be differentiated one more time and the zeros of the so determined second derivative function may be determined. Determining the smallest minimum and or the largest maximum of the derivative function may comprise to disregard locations, at which the values of the derivative function are smaller than a threshold value. In this way, it may be avoided that in absence of a distinct extremum, randomly distributed values are continually outputted.

The method may further comprise determining an edge distance value based on the argument of the derivative function at the smallest minimum and or at the largest maximum, wherein the edge distance value may represent an edge distance between the edge in the surface to be scanned and the sensor unit.

The disclosure also relates to a method of operating a screed of a road paver comprising a method of detecting an edge of the type described above and further comprising moving an extension part of the screed based on the determined edge distance value.

The method may further comprise setting a target value for the edge distance value. The method may further comprise defining a plausibility window around the target value, wherein the determined edge distance value is taken into account for moving of the extension part if the edge distance value is in the plausibility window and/or wherein the determined edge distance value is disregarded for moving the extension part if the determined edge distance value is outside the plausibility window. Method may comprise calculating a difference between the target value and the determined edge distance value. Outside of the plausibility window, the difference between the target value and the edge distance value may be assumed to be 0 according to the method.

Further, the sensor unit may comprise a 2-D lidar sensor. The emitting of laser pulse sequences may for example comprise emitting laser pulse sequences in the infrared spectrum, for example of infrared laser pulses. The method may further comprise detecting reflections of the laser pulse sequences, for example reflections in the infrared spectrum and/or reflections of infrared laser pulses, in particular by a photodiode. The photodiode may be provided as a part of the sensor unit. The method may comprise determining the distance value based on transit time measurement, for example by the sensor unit or by the edge detection system.

The method may comprise deflecting laser pulse sequences in the infrared spectrum and or infrared laser pulses into a plurality of directions, for example by a rotating mirror. The rotating mirror may be provided as a part of the sensor unit. The method may comprise determining the angle value based on an orientation of the mirror. The rotation frequency of the mirror may for example be between 1 Hz and 100 Hz, in particular between 1 Hz and 50 Hz, particularly preferred between 1 Hz and 30 Hz. The rotation frequency of the mirror may for example be 15 Hz. The method may comprise evaluating measurements in the range between −35° and 35°.

### BRIEF DESCRIPTION OF THE DRAWINGS

FIG. 1 shows a schematic side view of a road paver having an edge detection system;

FIG. 2 shows a schematic plan view from the top onto the road paver from FIG. 1;

FIG. 3 shows a schematic detailed view of the road paver from FIG. 1 and FIG. 2 from behind;

FIG. 4 shows a schematic diagram of an interpolating function generated on the basis of example distance measurements;

FIG. 5 shows a schematic diagram of a smoothed function generated based on the interpolating function from FIG. 4;

FIG. 6 shows a schematic diagram of a derivative function generated based on the smoothed function from FIG. 5; and

FIG. 7 shows a schematic diagram to illustrate connections between various components of the road finisher from FIGS. 1 to 3.

### DETAILED DESCRIPTION

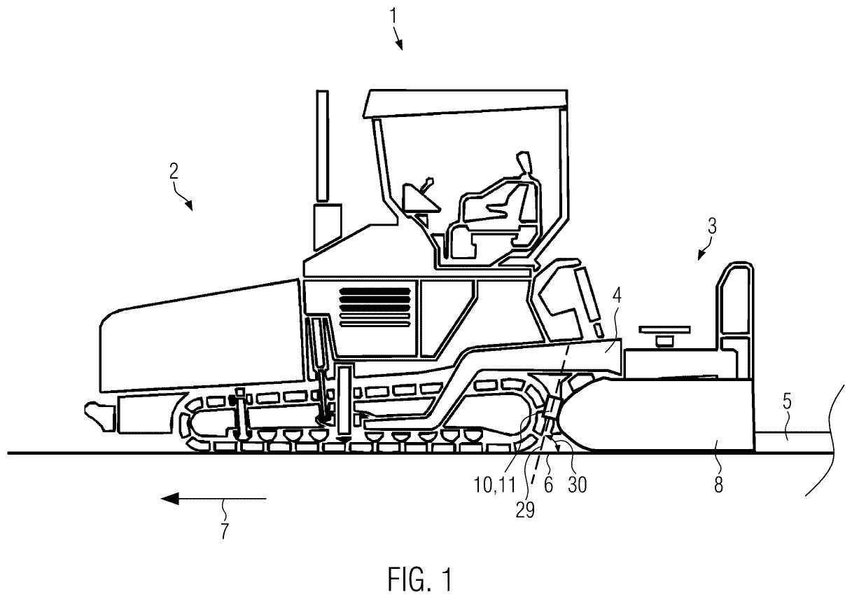

In FIG. 1, a road paver 1 is illustrated in a schematic side view. The road paver 1 may comprise a tractor 2. The road paver 1 may further comprise a screed 3. The tractor 2 may be configured to pull the screed 3. For this purpose, the road paver 1 may comprise pulling arms 4. The road paver 1 may be configured to apply a pavement 5 onto an underground 6. The road paver 1 may move in a driving direction 7.

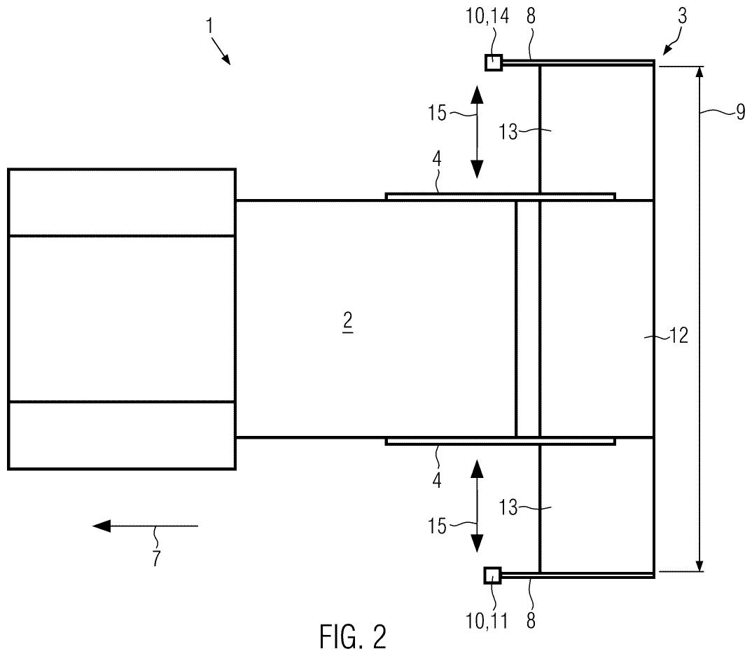

The screed 3 may comprise side shields 8. The side shields 8 may be configured to limit a paving width 9 (see FIG. 2) of the screed 3. In particular, the side shields 8 may be configured to limit the paving width 9 in a direction transverse with respect to the driving direction 7. The road paver 1 may further comprise an edge detection system 10. The edge detection system 10 may comprise a sensor unit 11. The sensor unit 11 may be disposed at one of the side shields 8.

In FIG. 2, the road paver 1 is illustrated in a schematic top view from above. Now it can be seen, that the screed 3 may comprise a basic screed 12. Further, the screed 3 may, as in the present embodiment, comprise two extension parts 13. The extension parts 13 may be movable relative to the basic screed 12, in particular along an extending direction 15. The extending direction 15 may be oriented transverse, in particular orthogonal, with respect to the driving direction 7. By moving the extension parts 13, the paving width 9 of the screed 3 may be adjustable. It can also be seen in FIG. 2 that the edge detection system 10 may comprise a second sensor unit 14. As shown in the present embodiment, the sensor unit 11 and the second sensor unit 14 may be disposed at opposite extension parts, in particular at opposite side shields 8, of the screed 3.

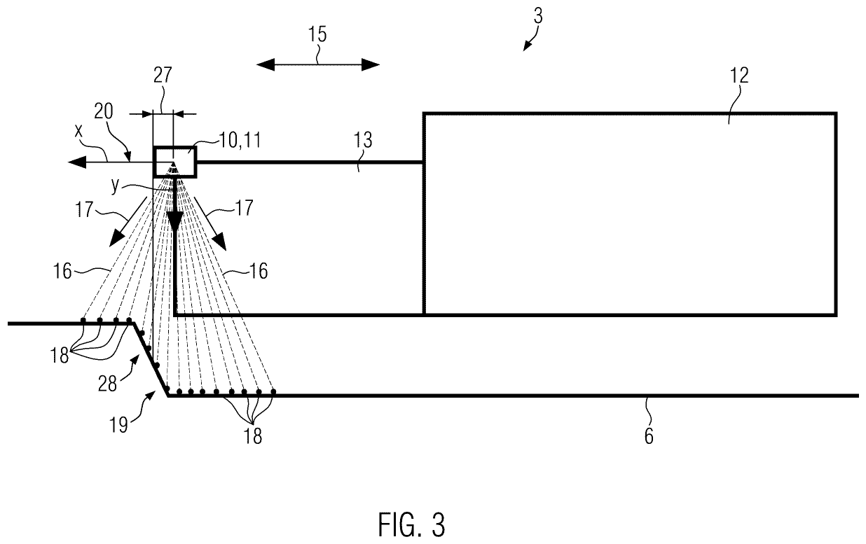

In FIG. 3, components of the screed 3 and of the edge detection system 10 are illustrated in more detail in a perspective from behind. It can be seen, that the sensor unit 11 may be configured to emit laser pulse sequences 16. The sensor unit 11 may be configured to emit laser pulse sequences 16 into a plurality of directions 17. As shown in the embodiment, the sensor unit 11 may be configured to emit the laser pulse sequences 16 in such a way that they are reflected at a plurality of locations 18 on a surface 19 to be scanned. As shown in the embodiment, a portion of the underground 6 may be regarded as a surface 19 to be scanned.

The reflections of the laser pulse sequences 16 may be detectable by the sensor unit 11. For example, reflections of the laser pulse sequences 16 may be detectable by a photodiode (not shown) of the sensor unit 11. The sensor unit 11 and or the edge detection system 10 may further be configured to determine a distance of the respective location 18 to the sensor unit 11 based on transit times of the laser pulse sequences 16 and their reflections. The sensor unit 11 and or the edge detection system 10 may be configured to generate polar coordinate signals based on said distance and the direction 17 of the respective laser pulse sequence. Each polar coordinate signal may be representative for a position of the respective location 18 relative to a polar coordinate system having an origin, which may for example be located inside the sensor unit 11.

The edge detection system 10 and or the sensor unit 11 may further be configured to generate Cartesian coordinate signals based on the polar coordinate signals. The Cartesian coordinate signals may represent Cartesian coordinates of the respective locations 18 relative to a Cartesian coordinate system 20. The origin of the Cartesian coordinate system 20 may be located inside the sensor unit 11, in particular in a point, in which the laser pulse sequences 16 are reflected in the respective direction 17.

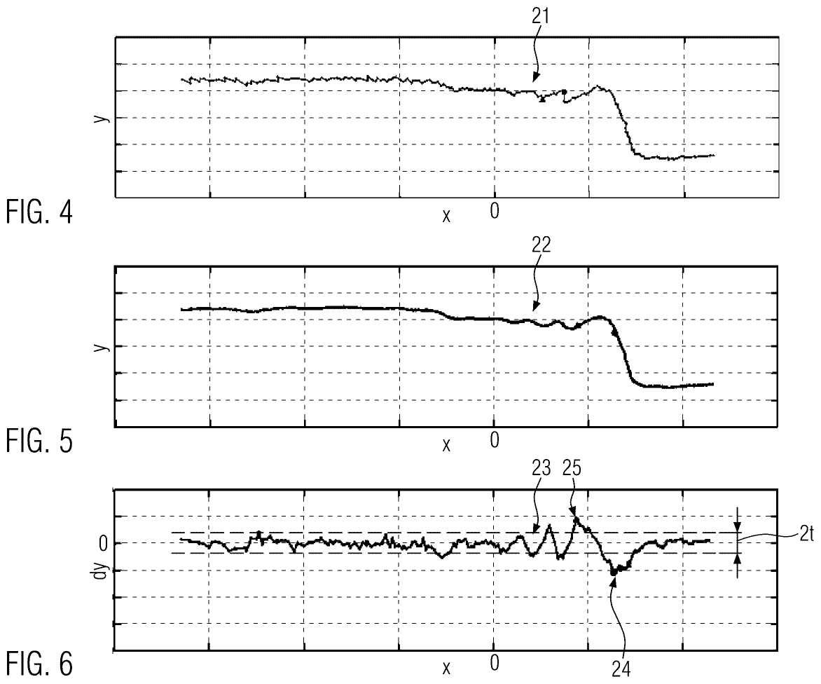

The edge detection system 10 and or the sensor unit 11 may be configured to determine and interpolating function 21 (see FIG. 4) based on the Cartesian coordinate signals. A schematic diagram of such an interpolating function 21 is illustrated as an example in FIG. 4. The edge detection system 10 and or the sensor unit 11 may further be configured to determine a smoothed function 22 based on the interpolating function 21. A schematic diagram of such a smoothed function 22 is shown as an example in FIG. 5. Further, the edge detection system 10 and or the sensor unit 11 may be configured to determine a derivative function 23 based on the smoothed function 22, in particular by differentiating the smoothed function 22. A schematic diagram of such a derivative function 23 is shown as an example in FIG. 6.

Further, the edge detection system 10 and/or the sensor unit 11 may be configured to determine the smallest minimum 24 and or the largest maximum 25 of the derivative function 23. An edge distance value 26 may be determined based on the smallest minimum 24 of the derivative function 23 and or based on the largest maximum 25 of the derivative function 23. In particular, the edge detection system 10 and or the sensor unit 11 may be configured to determine an edge distance value 26 based on the smallest minimum 24 of the derivative function 23 and or based on the largest maximum 25 of the derivative function 23. In the present embodiment, the smallest minimum 24 of the derivative function 23 is taken as a basis for determining the edge distance value 26, as will be explained in more detail further below. In particular, an argument of the derivative function 23 at the smallest minimum 24 of the derivative function 23 may be determined as the edge distance value 26. The edge distance value 26 may be regarded as representative for an edge distance 27 (see FIG. 3) between an edge 28 (see also FIG. 3) in the surface 19 to be scanned and the sensor unit 11.

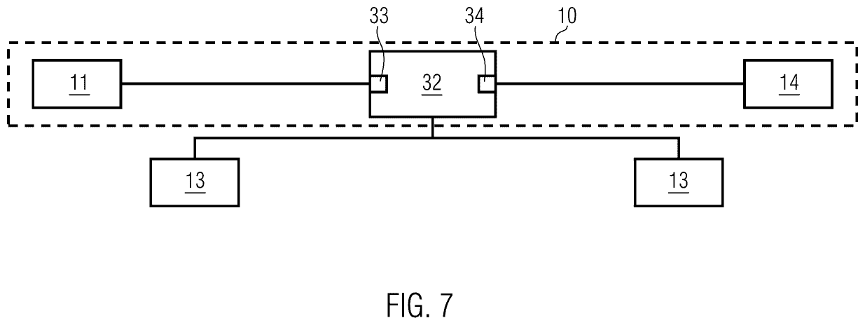

In FIG. 7, connections between the components of the edge detection system 10 and the screed 3 are schematically illustrated. It can be seen that the edge detection system 10 may comprise a control unit 32. The sensor unit 11 may be connected to a first connector of the control unit 32. The second sensor unit 14 may be connected to a second connector 34 of the control unit 32. The connection between the sensor units 11, 14 and the control unit 32 may for example be embodied as Ethernet. For example, the sensor unit 11 may have a static IP address, based on which the control unit 32 may recognize a mounting side of the sensor unit 11. Analogously, the second sensor unit 14 may have a static IP address, which may be different from the IP address of the sensor unit 11, and based on which the control unit 32 may determine a mounting side of the second sensor unit 14. Alternatively, or additionally, the first connector 33 and the second connector 34 may each be assigned to one mounting side. In this way, the control unit 32 may be configured to determine at which mounting side each sensor unit 11, 14 is disposed based on the connector at which the respective sensor unit 11, 14 is connected.

In that regard, as one skilled in the art would understand, the edge detection system 10, sensor unit(s) 11,14, control unit 32, as well an any other system, unit, controller, machine, apparatus, element, sensor, detector, device, component, subsystem, arrangement, or the like described herein may individually, collectively, or in any combination comprise appropriate circuitry, such as one or more appropriately programmed processors (e.g., one or more microprocessors including central processing units (CPU)) and associated memory which may include stored operating system software and/or application software executable by the processor(s) for controlling operation thereof and/or for performing the particular algorithms represented by the various functions and/or operations described herein, including interaction and/or cooperation between any such system, unit, controller, machine, apparatus, element, sensor, detector, device, component, subsystem, arrangement, or the like. One or more of such processors, as well as other circuitry and/or hardware, may be included in a single component (e.g., an ASIC (Application-Specific Integrated Circuit)), or several processors and various circuitry and/or hardware may be distributed among several separate components, whether individually packaged or assembled into a SoC (System-on-a-Chip).

In the following, the functioning of the edge detection system 10 in cooperation with the road paver 1 is further explained in summary and as an example based on FIGS. 1 to 7. The explanations primarily refer to the sensor unit 11. However, it should be clear that the explanations may be applicable to the second sensor unit 14 as well.

The sensor unit 11 may be disposed at the extension part 13, in particular at the side shield 8. As shown in the present embodiment in FIG. 1, the sensor may be mounted such that a plane 29 in which the plurality of directions 17 lie, is oriented at an angle 30 with respect to the underground 6 and or with respect to the driving direction 7. By adjusting the angle 30, it may be adjustable, how far the surface 19 to be scanned of the underground 6 is spaced from the trailing edge of the screed 3. By adjusting a mounting height of the sensor unit 11, a width of the surface 19 to be scanned may be adjustable.

As can be seen from FIG. 3, the x-coordinate of the Cartesian coordinate system 20, or the argument of the functions determined relative to this coordinate system 20, respectively, may be oriented parallel with respect to the extension direction 15 of the extension part 13, according to the embodiment. In a direction increasing the paving width 9 (to the left in FIG. 3) the x-coordinate of the Cartesian coordinate system 20 may become more positive. In the direction of a decrease of the paving width 9 (to the right in FIG. 3) the x-coordinate of the Cartesian coordinate system 20 a may become more negative. In order to be able to use identical sensor units for the sensor unit 11 and the second sensor unit 14, the x-coordinate of a coordinate system (not shown), which has an origin inside the second sensor unit 14 may be oriented in such a way that the x-coordinate becomes more positive in the direction of a decrease of the paving width 9.

As explained above with reference to FIG. 7, the edge detection system 10 may be configured to automatically recognize on which side of the screed 3 the sensor unit 11 and the second sensor unit 14 are disposed. In order to facilitate the edge detection, it may be settable by an operator, which type of edge is to be detected, for example with an edge sloping upwards or downwards towards the outside, should be detected. For example, a proposal based on initial measuring data may be offered to an operator by the edge detection system during set up of the respective sensor unit 11, 14. The operator may accept or change said proposal. Depending on the setting of the operator, the smallest minimum 24 of the derivative function 23 or the largest maximum 25 of the derivative function 23 may be searched for during the determination of the edge distance value 26.

When the side shield 8 is positioned at a desired position relative to the edge 28 and an edge is detected by the sensor unit 11, the operator may save the edge distance value 26 determined in this situation as a target value. If then the edge distance value 26 deviates from the target value, for example due to steering movements of the road paver or due to the course of the edge, a deviation may occur, for example a difference between the target value and the edge distance value 26. The corresponding extension part 13 may be controlled in such a way that the deviation is compensated.

With less distinctly defined edges, it may occur that the determination of the edge distance value 26 as explained above may yield alternating edge distance values 26. Unwanted consequences of this effect may be reduced by the inertia of the adjusting behavior of the screed 3, in particular of the extension parts 13. If the consequences of the effects described above are to be reduced even further, a run of the edge distance value 26 may be attenuated and thereby smoothed by a suitable filter, for example a low-pass filter.

Further, it may occur that an object causing detection of an unsuitable edge distance value 26, for example because it causes a higher slope in the smoothed function 22, appears in the surface 19 to be scanned. In order to reduce the consequences of such objects, the edge distance value may be subjected to a plausibility check before it is taken into account for setting the extension part 13. For example, a plausibility window may be defined around the target value. If the edge distance value 26 is inside the plausibility window, the calculated difference between the the target value and the edge distance value 26 may be taken into account when setting the extension part 13. If the edge distance value 26 is outside of the plausibility window, the difference between the target value and the edge distance value 26 may be assumed to be 0 such that the edge distance value 26 judged as implausible may be disregarded when setting the extension part 13.

What is claimed is:

1. An edge detection system for a road paver comprising:
a sensor unit configured to emit laser pulse sequences in a plurality of directions in such a way that the laser pulse sequences are reflected at a plurality of locations of a surface to be scanned;
wherein the sensor unit is further configured to detect reflections of the laser pulse sequences and, based on the detected reflections, generate polar coordinate signals representing polar coordinates, wherein the polar coordinates comprise a distance and an associated angle,
wherein the edge detection system is configured to transform the polar coordinate signals into Cartesian coordinate signals representing Cartesian coordinates and to determine a position of an edge in the surface to be scanned relative to a Cartesian coordinate system based on the Cartesian coordinate signals.

2. The edge detection system according to claim 1, wherein the edge detection system is configured to determine a smoothed function based on the Cartesian coordinate signals.

3. The edge detection system according to claim 2, wherein the edge detection system is configured to differentiate the smoothed function and determine a derivative function.

4. The edge detection system according to claim 3, wherein the edge detection system is configured to determine the smallest minimum and/or the largest maximum of the derivative function.

5. The edge detection system according to claim 4, wherein the edge detection system is configured to determine, based on the argument of the derivative function at the smallest minimum and/or at the largest maximum, an edge distance value, which represents an edge distance between the edge in the surface to be scanned and the sensor unit.

6. The edge detection system according to claim 1, wherein the edge detection system further comprises a second sensor unit and the edge detection system is configured to distinguish between the sensor unit and the second sensor unit based on their IP addresses.

7. A screed for a road paver, the screed comprising an edge detection system according to claim 1.

8. The screed for a road paver according to claim 7, further comprising at least one extension part, wherein the movement of the extension part is controllable based on an output of the edge detection system, wherein the output represents the edge distance value.

9. The screed according to claim 8, wherein the edge detection system is configured to control the movement of the extension part based on a target value representing a desired value for the edge distance value.

10. The screed according to claim 9, wherein the edge detection system is configured to define a plausibility window around the target value and wherein the edge detection system is configured to take the determined edge distance value into account for moving the extension part when the determined edge distance value is inside the plausibility window and/or to disregard the determined edge distance value for moving the extension part when the determined edge distance value is outside the plausibility window.

11. A road paver comprising an edge detection system according to claim 1.

12. The road paver according to claim 11, wherein a plane and a driving direction of the road paver enclose an angle, which is larger than 0° and/or smaller than 180°.

13. A method of detecting an edge by an edge detection system for a road paver, wherein the edge detection system comprises a sensor unit, the method comprising:
emitting laser pulse sequences into a plurality of directions by the sensor unit such that the laser pulse sequences are reflected at a plurality of locations of a surface to be scanned,
detecting reflections of the laser pulse sequences by the sensor unit,
generating polar coordinate signals representing polar coordinates based on the detected reflections, wherein the polar coordinates comprise a distance and an associated angle,
transforming the polar coordinate signals into Cartesian coordinate signals representing Cartesian coordinates, and
determining a position of an edge in the surface to be scanned relative to a Cartesian coordinate system based on the Cartesian coordinate signals.

14. The method according to claim 13, further comprising determining a smoothed function based on the Cartesian coordinate signals.

15. The method according to claim 14, further comprising differentiating the smoothed function and determining a derivative function.

16. The method according to claim 15, further comprising determining the smallest minimum and/or the largest maximum of the derivative function.

17. The method according to claim 16, further comprising determining an edge distance value based on the argument of the derivative function at the smallest minimum and/or at largest maximum, wherein the edge distance value represents an edge distance between the edge in the surface to be scanned and the sensor unit.

18. The method of operating a screed of a road paver comprising a method of detecting an edge according to claim 13 and further comprising moving an extension part of the screed based on the determined edge distance value.

19. The method according to claim 18, further comprising setting a target value for the edge distance value.

20. The method according to claim 19, further comprising defining a plausibility window around the target value, wherein the determined edge distance value is taken into account for moving the extension part if the determined edge distance value is inside the plausibility window and/or wherein the determined edge distance value is disregarded for moving the extension part if the determined edge distance value is outside the plausibility window.
